(19) United States
(12) Patent Application Publication
(10) Pub. No.: US 2016/0268918 A1
(43) Pub. Date: Sep. 15, 2016

(54) POWER SUPPLY WITH BY-PASS FUNCTION AND OPERATION METHOD

(71) Applicants: LITE-ON ELECTRONICS (GUANGZHOU) LIMITED, GUANGZHOU (CN); LITE-ON TECHNOLOGY CORPORATION, TAIPEI CITY (TW)

(72) Inventors: ZHEN WANG, NANJING CITY (CN); DONG XIANG, NANJING CITY (CN); XIAO-YI JIN, NANJING CITY (CN); ZHI-HONG YE, NANJING CITY (CN)

(21) Appl. No.: 14/929,441

(22) Filed: Nov. 2, 2015

(30) Foreign Application Priority Data
Mar. 9, 2015 (CN) 201510102804.7

(51) Int. Cl. H02M 7/04

(52) U.S. Cl. CPC H02M 7/04

(57) ABSTRACT

A power supply with by-pass function is provided. The power supply comprises an AC-to-DC converter, an input energy-storing capacitor, a ride through circuit, a DC-to-DC converter and an input voltage sensing and logic control circuit. When a voltage value of an input capacitor voltage is in the normal operation range, the ride through circuit outputs an output capacitor voltage according to a first control signal, wherein an output capacitor voltage is equal to the input capacitor voltage. When the voltage value of an input capacitor voltage is in the abnormal operation range, the ride through circuit outputs the output capacitor voltage according to a second control signal, wherein the output capacitor voltage is larger than the input capacitor voltage.

### BACKGROUND OF THE INVENTION

1. Field of the Invention

The instant disclosure relates to a power supply; in particular, to a power supply for increasing the power supply efficiency.

2. Description of Related Art

In recent years, the power supply circuit has been widely used in different electric products, such as portable electric products, computer products or the like. The power supply circuit can provide functions of voltage or current conversion or provide a constant voltage source or current source for the electric products. In the power supply circuit, the Power integrated circuit (Power IC) is one of the essential elements. In order to make the electric device (such as the desktop personal computer, the laptop, or the like) work normally, the AC voltage needs to be rectified and filtered via a power converter so as to provide a stable DC voltage to the electric device.

Please refer to the reference “Applied Power Electronics Conference and Exposition, 2003. APEC '03. Eighteenth Annual IEEE (Volume:2)”, especially, the FIG. 1 in the “A Combined Front End DC/DC Converter.” When the input side supplies power normally, the circuit forming by the elements L1, D2 and Q1 would not work and the element D1 provides a by-pass function. However, the element D1 (a diode) would generate a conduction loss that influences the power supply efficiency. When there is a power-down at the input side, the circuit formed by the elements L1, D2 and Q1 would provide the power stored in the storage capacitor to the power storage element C1, which maintains a normal output and extends the hold-up time. Moreover, the element D1 is not turned on all the time. As the input capacitor voltage is lower than the voltage of the output storage capacitor C1, two capacitors are cut off, so the voltage fluctuation range between two ends of the output capacitor voltage C1 would be larger than the voltage fluctuation range under the circumstance that two capacitors are connected in parallel.

Additionally, please refer to the reference U.S. Pat. No. 8,558,517, especially the FIG. 5. As the input voltage V_in is down, the element 611 (VIRTUAL_BY PASS SWITCH) would form a diode configuration and cannot be entirely cut off. Also, as the input voltage V_in is down, the power supply 100 in FIG. 5 would not obtain the voltage information of the element 30 (filter capacitor; power storage capacitor) to further have an appropriate reacting mechanism.

### SUMMARY OF THE INVENTION

In order to solve the above problems, the instant disclosure provides a power supply with a by-pass function. The power supply comprises an AC-to-DC converter, an input energy-storing capacitor, a ride through circuit, a DC-to-DC converter and an input voltage sensing and logic control circuit. The AC-to-DC converter is configured to receive an AC input voltage and to convert the AC input voltage into an input capacitor voltage. The input energy-storing capacitor is connected to the AC-to-DC converter in parallel, to store the input capacitor voltage. The ride through circuit is electrically connected to the input energy-storing capacitor to receive the input capacitor voltage, wherein the ride through circuit outputs an output capacitor voltage respectively according to a first control signal and a second control signal. The DC-to-DC converter is electrically connected to the ride through circuit to receive the output capacitor voltage and to convert the output capacitor voltage into a DC output voltage. The input voltage sensing and logic control circuit is electrically connected to the ride through circuit to detect the input capacitor voltage and output the first control signal and the second control signal to the ride through circuit according to the input capacitor voltage. As the input capacitor voltage is within a normal operation range, the ride through circuit outputs the output capacitor voltage according to the first control signal, wherein the output capacitor voltage equals to the input capacitor voltage.

In one of embodiments of the instant disclosure, as the input capacitor voltage is within an abnormal operation range, the ride through circuit outputs the output capacitor voltage according to the second control signal, wherein the output capacitor voltage is larger than the input capacitor voltage. On the other hand, as the input capacitor voltage is lower than a lower bound of the abnormal operation range, the ride through circuit stops working and further turns off the power supply.

In one of embodiments of the instant disclosure, the ride through circuit comprises a first switch, a first inductor, a first diode, a second switch and an output energy-storing capacitor. The first switch has one end connected to one end of the first capacitor to receive the first control signal and determines a turn-on state or a turn-off state according to the first control signal. The first inductor has one end connected to one end of the first switch. The first diode has an anode connected to another end of the first inductor and has a cathode connected to another end of the first switch. The second switch has one end connected to the anode of the first diode to receive the second control signal and to determine a turn-on state or a turn-off state according to the second control signal. The output energy-storing capacitor has one end connected to another end of the first switch and has another end connected to the second switch and another end of the first capacitor. As the first switch is turned on, the input energy-storing capacitor and the output energy-storing capacitor connects to each other for reducing the voltage fluctuation of the output energy-storing capacitor.

In one of embodiments of the instant disclosure, as the input capacitor voltage is within the normal operation range, the first switch receives the first control signal at a high voltage level and the second switch receives the second control signal at a low voltage level, such that the output energy-storing capacitor generates the output capacitor voltage via the first switch to make the DC-to-DC converter work normally.

In one of embodiments of the instant disclosure, as the input capacitor voltage is within the abnormal operation range, the first switch receives the first control signal at a low voltage level and the second switch receives the second control signal at the high voltage level, such that output energy-storing capacitor generates the output capacitor voltage via the first inductor, the first diode and the second switch to make the DC-to-DC converter work normally. On the other hand, as the input capacitor voltage is lower than a lower bound of the abnormal operation range, the first switch receives the first control signal at a low voltage level and the second switch receives the second control signal at a low voltage level, such that the first switch and the second switch are turned off simultaneously and the power supply is further turned off.

The instant disclosure further provides an operation method of a power supply. The power supply comprises an AC-to-DC converter, an input energy-storing capacitor, a ride through circuit, a DC-to-DC converter and an input voltage sensing and logic control circuit. The input energy-storing capacitor is connected to the AC-to-DC converter in parallel. The ride through circuit is electrically connected to the input energy-storing capacitor. The DC-to-DC converter is electrically connected to the ride through circuit. The input voltage sensing and logic control circuit is electrically connected to the ride through circuit, wherein the ride through circuit comprises a first switch, a first inductor, a first diode, a second switch and an output energy-storing capacitor. The operation method comprises: inputting an AC input voltage and converting the AC input voltage into an input capacitor voltage via the AC-to-DC converter; soft-starting; determining whether the soft-starting is finished; turning on a first switch and turning off a second switch if the soft-starting is finished; determining whether the input capacitor voltage is normal; determining whether the input capacitor voltage is within an operation range of the ride through circuit if the input capacitor voltage is abnormal; and turning off the first switch and turning on the second switch if the input capacitor voltage is within the operation range of the ride through circuit.

To sum up, in the power supply and the operation method thereof provided by the instant disclosure, as the input capacitor voltage is within the normal operation range, the ride through circuit outputs an output capacitor voltage according to the first control signal, wherein the output capacitor voltage equals to the input capacitor voltage. Accordingly, there's almost no power consumption during the power transmission or power conversion, which helps to increase the power supply efficiency. As the input capacitor voltage is within the abnormal operation range, the ride through circuit boosts the input capacitor voltage according to the second control signal so as to output an output capacitor voltage, wherein the output capacitor voltage is larger than the input capacitor voltage. Accordingly, the hold-up time can be increased, or merely smaller power storage elements, such as capacitors, are needed to maintain the same hold-up time.

For further understanding of the instant disclosure, reference is made to the following detailed description illustrating the embodiments and embodiments of the instant disclosure. The description is only for illustrating the instant disclosure, not for limiting the scope of the claims.

### BRIEF DESCRIPTION OF THE DRAWINGS

Embodiments are illustrated by way of example and not by way of limitation in the figures of the accompanying drawings, in which like references indicate similar elements and in which:

FIG. 1 shows a schematic drawing of a power supply of one embodiment of the instant disclosure.

FIG. 2 shows an operation flow chart of a power supply of one embodiment of the instant disclosure.

### DETAILED DESCRIPTION OF PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

It will be understood that, although the terms first, second, third, and the like, may be used herein to describe various elements or components, these elements or components should not be limited by these terms. These terms are only to distinguish one element or component from another element or component discussed below and could be termed a second element or component without departing from the teachings of the instant disclosure. As used herein, the term “and/or” includes any and all combinations of one or more of the associated listed items.

[One Embodiment of a Power Supply]

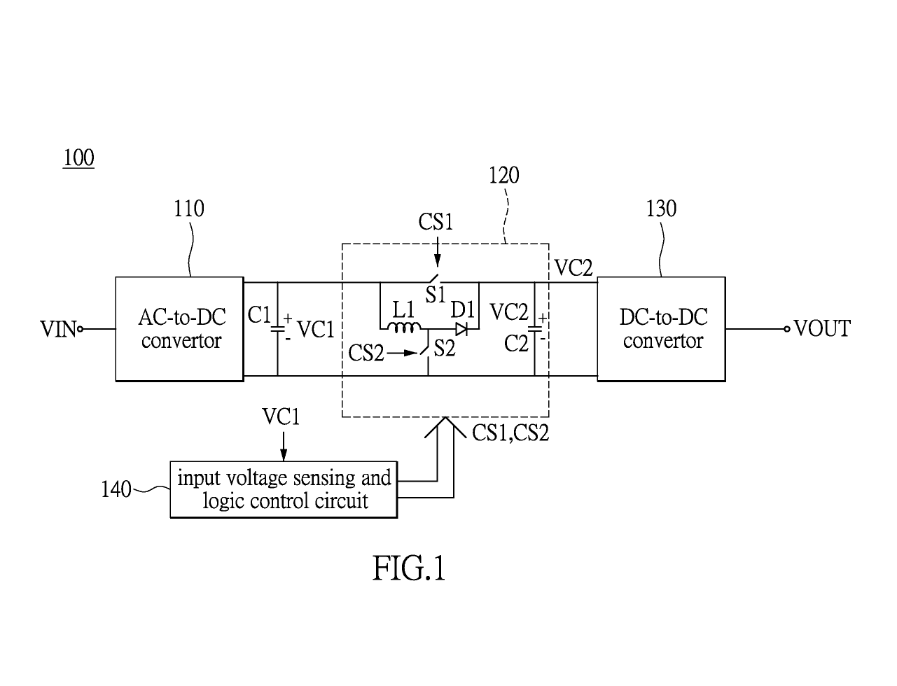

Please refer to FIG. 1. FIG. 1 shows a schematic drawing of a power supply of one embodiment of the instant disclosure. As shown in FIG. 1, the power supply 100 comprises an AC-to-DC converter 110, an input energy-storing capacitor C1, a ride through circuit 120, a DC-to-DC converter 130 and an input voltage sensing and logic control circuit 140. The input energy-storing capacitor C1 is connected to the AC-to-DC converter 110 in parallel. The ride through circuit 120 is electrically connected to the input energy-storing capacitor C1. The DC-to-DC converter 130 is electrically connected to the ride through circuit 120. The input voltage sensing and logic control circuit 140 is electrically connected to the ride through circuit 120.

In this embodiment, the AC-to-DC converter 110 is configured to receive an AC input voltage VIN and to convert the AC input voltage VIN into an input capacitor voltage VC1, and the input energy-storing capacitor C1 is configured to store the input capacitor voltage VC1. After that, the ride through circuit 120 outputs an output capacitor voltage VC2 respectively according to the received first control signal CS1 and the received second control signal CS2. The DC-to-DC converter 130 receives the output capacitor voltage VC2, and converts the output capacitor voltage VC2 into a DC output voltage VOUT. It is worth mentioning that the input voltage sensing and logic control circuit 140 in the instant disclosure will detect the input capacitor voltage VC1 and outputs a first control signal CS1 and a second control signal CS2 to the ride through circuit 120 according to the detected input capacitor voltage VC1, in order to control the operation mode of the ride through circuit 120. In other words, in this embodiment, whether the input side of the power supply 100 normally supplies power is detected by the input voltage sensing and logic control circuit 140 in a manner of firmware, and the operation of the power supply 100 is timely controlled by the control signals CS1 and CS2 that are output to the ride through circuit 120 according to the power supply condition.

Specifically speaking, in the condition that the input side of the power supply 100 normally supplies power, as the input voltage sensing and logic control circuit 140 detects that the input capacitor voltage VC1 is within a normal operation range (such as 300V˜450V), the input voltage sensing and logic control circuit 140 sends a first control signal CS1 at a high voltage level to the ride through circuit 120. After that, the ride through circuit 120 outputs the output capacitor voltage VC2 to the DC-to-DC converter 130 for operation according to the first control signal CS1. It should be noted that, in this embodiment, the output capacitor voltage VC2 equals to the input capacitor voltage VC1, which indicates that there is almost no power consumption during the power transmission or the power conversion and it is helpful for increasing the power supply efficiency.

On the other hand, in a power-down mode of the input side of the power supply 100, as the input voltage sensing and logic control circuit 140 detects that the input capacitor voltage VC1 is within an abnormal operation range, such as 200V˜300V, the input voltage sensing and logic control circuit 140 sends a second control signal CS2 at a high voltage level to the ride through circuit 120. After that, the ride through circuit 120, according to the second control signal CS2, starts the boosting mechanism to output an output capacitor voltage VC2 to the DC-to-DC converter 130 for a normal operation. In this embodiment, the output capacitor voltage VC2 is larger than the input capacitor voltage VC1. In other words, via this embodiment, the hold-up time can be increased, or merely smaller power storage elements, such as capacitors, are needed to maintain the same hold-up time.

Finally, in a mode that there is a dramatic power-down at the input side of the power supply 100, as the input voltage sensing and logic control circuit 140 detects that the input capacitor voltage VC1 is lower than the lower bound of the abnormal operation range (for example, lower than 200V), the input voltage sensing and logic control circuit 140 simultaneously sends the control signals CS1 and CS2 at a low voltage level to the ride through circuit 120, in order to stop the ride through circuit 120 and further to turn off the power supply 100 for preventing the circuit elements from damage.

[Another Embodiment of the Power Supply]

Please again refer to FIG. 1. The ride through circuit 120 comprises a first switch S1, a first inductor L1, a first diode D1, a second switch S2 and an output energy-storing capacitor C2. One end of the first switch S1 is connected to one end of the first capacitor C1 for receiving the first control signal CS1 and accordingly determining a turn-on state or a turn-off state. One end of the first inductor L1 is connected to one end of the first switch S1. The anode of the first diode D1 is connected to another end of the first inductor L1, and the cathode of the first diode D1 is connected to another end of the first switch S1. One end of the second switch S2 is connected to the anode of the first diode D1 for receiving the second control signal CS2 and accordingly determining a turn-on state or a turn-off state. One end of the output energy-storing capacitor C2 is connected to the another end of the first switch S1, and another end of the output energy-storing capacitor C2 is connected to the second switch S2 and another end of the first capacitor C1.

Specifically speaking, in the condition that the input side of the power supply 100 normally supplies power, as the input voltage sensing and logic control circuit 140 detects that the input capacitor voltage VC1 is within a normal operation range (such as 300 v˜450V), the first switch S1 receives the first control signal CS1 at a high voltage level sent from the input voltage sensing and logic control circuit 140. On the other hand, the second switch S2 receives the second control signal CS2 at a low voltage level, such that the output energy-storing capacitor C2 generates the output capacitor voltage VC2 via power transmission of the first switch S1 to make the DC-to-DC converter 130 operate normally and to generate the DC output voltage VOUT. It is worth mentioning that, in this embodiment, as the first switch S1 is turned on, the input energy-storing capacitor C1 and the output energy-storing capacitor C2 are connected with each other in parallel for reducing a voltage fluctuation of the output energy-storing capacitor C2. Moreover, there is almost no power consumption during the power transmission or the power converting, which helps to increase the power supply efficiency.

On the other hand, in a power-down mode of the input side of the power supply 100, as the input voltage sensing and logic control circuit 140 detects that the input capacitor voltage VC1 is within an abnormal operation range, such as 200V˜300V, the first switch S1 receives the first control signal CS1 at a low voltage level sent from the input voltage sensing and logic control circuit 140, and the second switch S2 receives the second control signal CS2 such that the output energy-storing capacitor C2 generates an output capacitor voltage VC2 via the first inductor L1, the first diode D1 and the second switch S2 (forming a boost circuit) so as to make the DC-to-DC converter 130 work normally and further to generate a DC output voltage VOUT. In other words, via this embodiment, the hold-up time can be increased, or merely smaller power storage elements, such as capacitors, are needed to maintain the same hold-up time.

Finally, in a mode that there is a dramatic power-down at the input side of the power supply 100, as input voltage sensing and logic control circuit 140 detects that the input capacitor voltage VC1 is lower than the lower bound of an abnormal operation range (for example, lower than 200V), the first switch S1 receives the first control signal CS1 at a low voltage level sent from the input voltage sensing and logic control circuit 140. Moreover, the second switch S2 receives the second control signal CS2 at a low voltage level sent from the input voltage sensing and logic control circuit 140. Thereby, the switches S1 and S2 are turned off simultaneously, and the power supply 100 is further turned off.

In the following description, an operation flow chart of a power supply is used to illustrate the embodiment of the instant disclosure.

[One Embodiment of an Operation Method of the Power Supply]

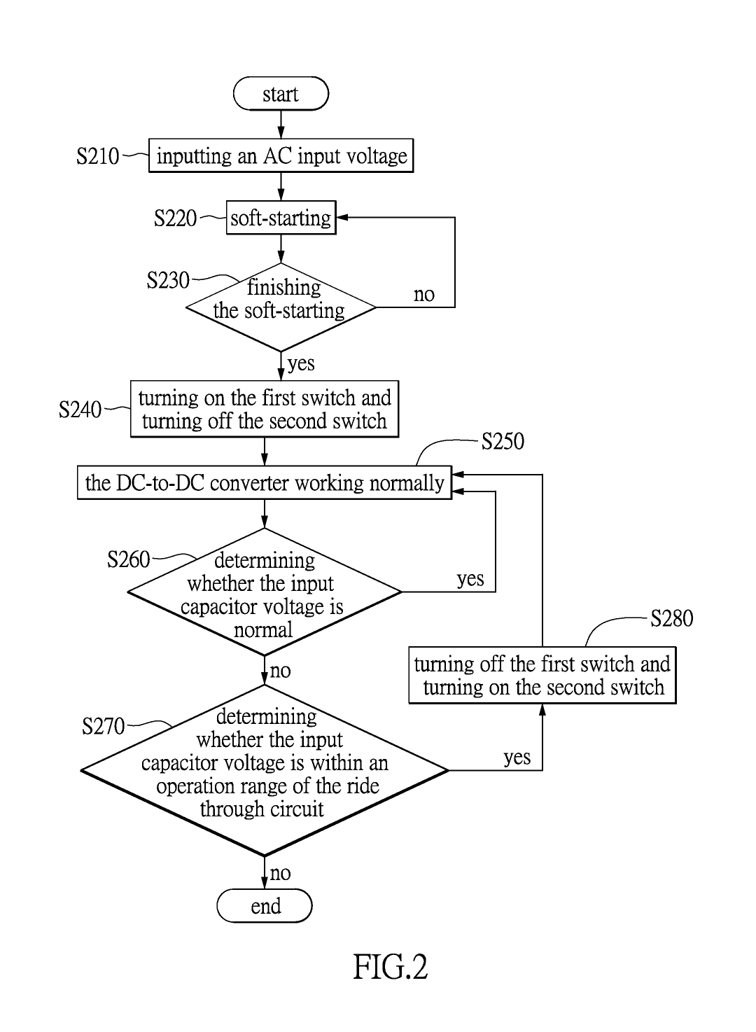

In conjunction with FIG. 1 and FIG. 2, FIG. 2 shows an operation flow chart of a power supply of one embodiment of the instant disclosure. As shown in FIG. 2, the operation of the power supply comprises the following steps: inputting an AC input voltage (Step S210); soft-starting (Step S220); finishing the soft-starting (Step S230); turning on the first switch and turning off the second switch (Step S240); the DC-to-DC converter working normally (Step S250); determining whether the input capacitor voltage is normal (Step S260); determining whether the input capacitor voltage is within an operation range of the ride through circuit (Step S270); and turning off the first switch and turning on the second switch (Step S280).

In the Step S210, the input side of the power supply 100 receives the AC input voltage VIN. After that, it goes to the Step S220.

In the Step S220, the power supply 100 goes to the step of soft-starting and then goes to the Step S230.

In the Step S230, if the soft starting has not yet finished, it returns to the Step S220 to soft start the power supply 100, and if the soft starting has finished, it goes to the Step S240.

In the Step S240, as the input voltage sensing and logic control circuit 140 detects that the input capacitor voltage is within a normal operation range (such as 300V˜450V), the first switch S1 receives the first control signal CS1 at a high voltage level sent from the input voltage sensing and logic control circuit 140 to be turned on, and the second switch S2 receives the second control signal CS2 at a low voltage level to be turned off or cut off After that, output energy-storing capacitor C2 transmits power via the first switch S1 to generate an output capacitor voltage VC2, and then it goes to the Step S250.

In the Step S250, after the DC-to-DC converter 130 receives the output capacitor voltage VC2 to work normally and to further generate a DC output voltage VOUT, it goes to the Step S260.

In the Step S260, the input voltage sensing and logic control circuit 140 continues to detect whether the input capacitor voltage VC1 is normal. If the input capacitor voltage VC1 is within a normal operation range (such as 300V˜450V), it goes to the Step S250. If the input capacitor voltage VC1 is within an abnormal operation range (such as 200V˜300V), it goes to the Step S270 for determining the next condition.

In the Step S270, the input voltage sensing and logic control circuit 140 further determines whether the input capacitor voltage VC1 is lower than the operation range of the ride through circuit 120. If the input capacitor voltage VC1 is lower than the operation range of the ride through circuit 120, it means that there is a dramatic power-down at the input side of the power supply 100. Thus, the first switch S1 will receive the first control signal CS1 at a low voltage level sent form the input voltage sensing and logic control circuit 140 and the second switch S2 will receive the second control signal CS2 at a low voltage level sent from the input voltage sensing and logic control circuit 140, so as to turn off the first switch S1 and the second switch S2 simultaneously and further to turn off the power supply 100. On the other hand, if the input capacitor voltage VC1 is not lower than the operation range of the ride through circuit 120, it goes to the Step S280.

In the Step S280, the first switch S1 receives the first control signal CS1 at a low voltage level sent from the input voltage sensing and logic control circuit 140 and the second switch S2 receives the second control signal CS2 at a high voltage level sent from the input voltage sensing and logic control circuit 140, such that the output energy-storing capacitor C2 generates the output capacitor voltage VC2 via the first inductor L1, the first diode D1 and the second switch S2 (forming a boost circuit) to make the DC-to-DC converter 130 work normally and further to generate a DC output voltage VOUT.

To sum up, in the power supply and the operation method thereof provided by the instant disclosure, as the input capacitor voltage is within the normal operation range, the ride through circuit outputs an output capacitor voltage according to the first control signal, wherein the output capacitor voltage equals to the input capacitor voltage. Accordingly, there's almost no power consumption during the power transmission or power conversion, which helps to increase the power supply efficiency. As the input capacitor voltage is within the abnormal operation range, the ride through circuit boosts the input capacitor voltage according to the second control signal so as to output an output capacitor voltage, wherein the output capacitor voltage is larger than the input capacitor voltage. Accordingly, via the instant disclosure, the hold-up time can be increased, or merely smaller power storage elements, such as capacitors, are needed to maintain the same hold-up time.

The descriptions illustrated supra set forth simply the preferred embodiments of the instant disclosure; however, the characteristics of the instant disclosure are by no means restricted thereto. All changes, alterations, or modifications conveniently considered by those skilled in the art are deemed to be encompassed within the scope of the instant disclosure delineated by the following claims.

What is claimed is:

1. A power supply with a by-pass function, comprising:
an AC-to-DC converter, configured to receive an AC input voltage and to convert the AC input voltage into an input capacitor voltage;
an input energy-storing capacitor, connected to the AC-to-DC converter in parallel, to store the input capacitor voltage;
a ride through circuit, electrically connected to the input energy-storing capacitor to receive the input capacitor voltage, wherein the ride through circuit outputs an output capacitor voltage respectively according to a first control signal and a second control signal;
a DC-to-DC converter, electrically connected to the ride through circuit to receive the output capacitor voltage and to convert the output capacitor voltage into a DC output voltage; and
an input voltage sensing and logic control circuit, electrically connected to the ride through circuit to detect the input capacitor voltage and output the first control signal and the second control signal to the ride through circuit according to the input capacitor voltage;
wherein as the input capacitor voltage is within a normal operation range, the ride through circuit outputs the output capacitor voltage according to the first control signal, and the output capacitor voltage equals to the input capacitor voltage.

2. The power supply according to claim 1,
wherein as the input capacitor voltage is within an abnormal operation range, the ride through circuit boosts the input capacitor voltage according to the second control signal so as to output an output capacitor voltage, and the output capacitor voltage is larger than the input capacitor voltage;
wherein as the input capacitor voltage is lower than a lower bound of the abnormal operation range, the ride through circuit stops working and further turns off the power supply.

3. The power supply according to claim 1, wherein the ride through circuit comprises:
a first switch, having one end connected to one end of the first capacitor to receive the first control signal and determines a turn-on state or a turn-off state according to the first control signal;
a first inductor, having one end connected to one end of the first switch;
a first diode, having an anode connected to another end of the first inductor and having a cathode connected to another end of the first switch;
a second switch, having one end connected to the anode of the first diode to receive the second control signal and to determine a turn-on state or a turn-off state according to the second control signal; and
an output energy-storing capacitor, having one end connected to another end of the first switch and having another end connected to the second switch and another end of the first capacitor;
wherein as the first switch is turned on, the input energy-storing capacitor and the output energy-storing capacitor connects to each other for reducing the voltage fluctuation of the output energy-storing capacitor.

4. The power supply according to claim 3, wherein as the input capacitor voltage is within the normal operation range, the first switch receives the first control signal at a high voltage level and the second switch receives the second control signal at a low voltage level, such that the output energy-storing capacitor generates the output capacitor voltage via the first switch to make the DC-to-DC converter work normally.

5. The power supply according to claim 3,
wherein as the input capacitor voltage is within the abnormal operation range, the first switch receives the first control signal at a low voltage level and the second switch receives the second control signal at the high voltage level, such that output energy-storing capacitor generates the output capacitor voltage via the first inductor, the first diode and the second switch to make the DC-to-DC converter work normally; and
wherein as the input capacitor voltage is lower than a lower bound of the abnormal operation range, the first switch receives the first control signal at a low voltage level and the second switch receives the second control signal at a low voltage level, such that the first switch and the second switch are turned off simultaneously and the power supply is further turned off.

6. An operation method of a power supply, wherein the power supply comprises an AC-to-DC converter, an input energy-storing capacitor, a ride through circuit, a DC-to-DC converter and an input voltage sensing and logic control circuit, wherein the input energy-storing capacitor is connected to the AC-to-DC converter in parallel, the ride through circuit is electrically connected to the input energy-storing capacitor, the DC-to-DC converter is electrically connected to the ride through circuit, the input voltage sensing and logic control circuit is electrically connected to the ride through circuit, wherein the ride through circuit comprises a first switch, a first inductor, a first diode, a second switch and an output energy-storing capacitor, the operation method comprising:
inputting an AC input voltage and converting the AC input voltage in to an input capacitor voltage via the AC-to-DC converter;
soft-starting;
determining whether the soft-starting is finished;
turning on a first switch and turning off a second switch if the soft-starting is finished;
making the DC-to-DC converter work normally;
determining whether the input capacitor voltage is normal;
determining whether the input capacitor voltage is within an operation range of the ride through circuit if the input capacitor voltage is abnormal; and
turning off the first switch and turning on the second switch if the input capacitor voltage is within the operation range of the ride through circuit;
wherein one end of the first switch is connected to one end of the first capacitor, one end of the first inductor is connected to one end of the first switch, an anode and a cathode of the first diode are respectively connected to another end of the first inductor and another end of the first switch, one end of the second switch is connected to the anode of the first diode, two ends of the output energy-storing capacitor are respectively connected to another end of the first switch and the second switch, and to another end of the first capacitor.

7. The operation method according to claim 6, wherein the DC-to-DC converter works normally if the input capacitor voltage is normal, and the power supply stops working if the input capacitor voltage is lower than a lower bound of the operation range of the ride through circuit.

8. The operation method according to claim 6,
wherein as the input capacitor voltage is within the normal operation range, the ride through circuit outputs the output capacitor voltage according to a first control signal, wherein the output capacitor voltage equals to the input capacitor voltage;
wherein as the input capacitor voltage is within the abnormal operation range, the ride through circuit boosts the input capacitor voltage according to the second control signal so as to output an output capacitor voltage, wherein the output capacitor voltage is larger than the input capacitor voltage;
wherein as the input capacitor voltage is lower than a lower bound of the abnormal operation range, the ride through circuit stops working and the power supply is further turned off.

9. The operation method according to claim 8, wherein as the input capacitor voltage is within the normal operation range, the first switch receives the first control signal at a high voltage level and the second switch receives the second control signal at a low voltage level, such that the output energy-storing capacitor generates the output capacitor voltage via the first switch to make the DC-to-DC converter work normally.

10. The operation method according to claim 8,
wherein as the input capacitor voltage is within the abnormal operation range, the first switch receives the first control signal at a low voltage level and the second switch receives the second control signal at the high voltage level, such that output energy-storing capacitor generates the output capacitor voltage via the first inductor, the first diode and the second switch to make the DC-to-DC converter work normally; and
wherein as the input capacitor voltage is lower than a lower bound of the abnormal operation range, the first switch receives the first control signal at a low voltage level and the second switch receives the second control signal at a low voltage level, such that the first switch and the second switch are turned off simultaneously and the power supply is further turned off.
